(19) United States
(12) Patent Application Publication
(10) Pub. No.: US 2013/0105730 A1
(43) Pub. Date: May 2, 2013

(54) LITHIUM-TITANIUM COMPLEX OXIDE, AND BATTERY ELECTRODE AND LITHIUM ION SECONDARY BATTERY USING SAME

(71) Applicant: TAIYO YUDEN CO., LTD., Tokyo (JP)

(72) Inventors: Akitoshi WAGAWA, Takasaki-shi (JP); Daigo ITO, Takasaki-shi (JP); Chie KAWAMURA, Takasaki-shi (JP); Masaki MOCHIGI, Takasaki-shi (JP); Toshiyuki OCHIAI, Takasaki-shi (JP); Yoichiro OGATA, Takasaki-shi (JP); Toshimasa SUZUKI, Takasaki-shi (JP)

(73) Assignee: TAIYO YUDEN CO., LTD., Tokyo, (JP)

(21) Appl. No.: 13/654,162

(22) Filed: Oct. 17, 2012

(30) Foreign Application Priority Data
Nov. 2, 2011 (JP) 2011-241735

(51) Int. Cl. H01M 4/485

(52) U.S. Cl. 252/182.1; 429/231.1

(57) ABSTRACT

A lithium-titanium complex oxide manufactured by the solid phase method is suitable as an active material for a lithium ion secondary battery capable of achieving both a high capacity and high rate characteristics. The main constituent of the lithium-titanium complex oxide is Li₄Ti₅O₁₂ and, when the main peak intensities of each Li₄Ti₅O₁₂, Li₂TiO₃ and TiO₂ phase detected from an X-ray diffraction pattern are given by I₁, I₂ and I₃, respectively, I₁/(I₁+I₂+I₃) is 96% or more, where the crystallite size of Li₄Ti₅O₁₂ as calculated by Scherrer's equation from the half width of the peak on its (111) plane in the above X-ray diffraction pattern is 520 Å to 590 Å.

### BACKGROUND

1. Field of the Invention

The present invention relates to a lithium-titanium complex oxide which is suitable as the material for electrodes of a lithium ion secondary battery.

2. Description of the Related Art

Lithium-titanium complex oxide, whose main constituent is lithium titanate, and to which trace constituents have been added as necessary, is a material which is beginning to be adopted for lithium ion secondary battery products where safety is paramount. Lithium-titanium complex oxides undergo little volume change and are highly safe. Lithium ion secondary batteries using these lithium-titanium complex oxides for their negative electrodes are beginning to be used in automotive and infrastructure applications. However, the market is demanding significant reduction of battery cost. Carbon materials are generally used to make negative electrodes and, although their safety is inferior to lithium-titanium complex oxide, carbon materials offer high capacity and are much cheaper than a lithium-titanium complex oxide. Accordingly, it is important to maintain the high performance of a lithium-titanium complex oxide and still increase the efficiency of their manufacturing process. The performance (electrochemical characteristics) required of a lithium-titanium complex oxide includes high capacity, high rate characteristics (high-speed charge/discharge) and long life. To achieve these requirements, desirably the percentage of Li₄Ti₅O₁₂ in the product powder represents a high purity of 96% or more, for example, and also has a large surface area in consideration of subsequent dipping in electrolyte solution.

According to Patent Literature 1, a highly crystalline lithium-titanium complex oxide whose main constituent is Li_{4/3}Ti_{5/3}O₄, which contains less anatase titanium dioxide, rutile titanium dioxide and Li₂TiO₃, and whose crystallite size is 700 Å to 800 Å, can be applied as an active material for lithium ion secondary batteries to provide a high charge/discharge capacity.

### BACKGROUND ART LITERATURES

[Patent Literature 1] Japanese Patent No. 4435926

### SUMMARY

However, the highly crystalline lithium titanate described in Patent Literature 1, although having a charge/discharge capacity close to a theoretical capacity, sees its primary particle increase in size as the crystallite size increases, which causes the lithium ion insertion speed to drop and prevents the rate characteristics of the battery from improving. On the other hand, it is possible to make a highly crystalline powder finer by crushing it using a bead mill, etc. However, doing so damages the surface state of the crystal and reduces the crystallinity, causing the crystallite size of the particle to drop. As a result, the charge/discharge curve becomes strained in a manner making the flat portion of the charge/discharge curve shorter, and this lowers the effective capacity, as discovered by the inventors of the present invention.

In consideration of the above, an object of the present invention is to provide a lithium-titanium complex oxide that can be manufactured by the solid phase method associated with low manufacturing cost and to achieve both high capacity and high rate characteristics.

Any discussion of problems and solutions involved in the related art has been included in this disclosure solely for the purposes of providing a context for the present invention, and should not be taken as an admission that any or all of the discussion were known at the time the invention was made.

After studying in earnest, the inventors of the present invention completed the present invention characterized as follows.

The present invention is a lithium-titanium complex oxide whose main constituent is Li₄Ti₅O₁₂ and, when the main peak intensities of Li₄Ti₅O₁₂, Li₂TiO₃ and TiO₂ detected from an X-ray diffraction pattern are given by I₁, I₂ and I₃, respectively, I₁/(I₁+I₂+I₃) is 96% or more. In addition, the crystallite size of Li₄Ti₅O₁₂ as calculated by Scherrer's equation from the half width of the peak on the Li₄Ti₅O₁₂ (111) plane is 520 Å to 590 Å. Preferably the specific surface area of the lithium-titanium complex oxide obtained by the BET method is 8 to 12 m²/g. Also, preferably the maximum primary particle size of the lithium-titanium complex oxide is 1.5 μm or less.

According to another favorable embodiment of the present invention, A₁/A₂ is 4 or less, where A₁ represents the specific surface area-equivalent diameter of the lithium-titanium complex oxide as calculated from the specific surface area obtained by the BET method, while A₂ represents the crystallite size of Li₄Ti₅O₁₂ as calculated by Scherrer's equation.

According to the present invention, a battery electrode (positive electrode or negative electrode) using the aforementioned lithium-titanium complex oxide, and a lithium ion secondary battery having such electrodes, are also provided.

According to the present invention, a lithium-titanium complex oxide is obtained that can be manufactured by the solid phase method and is suitable as an active electrode material for a lithium ion secondary battery offering a high effective capacity and excellent rate characteristics.

For purposes of summarizing aspects of the invention and the advantages achieved over the related art, certain objects and advantages of the invention are described in this disclosure. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Further aspects, features and advantages of this invention will become apparent from the detailed description which follows.

### BRIEF DESCRIPTION OF THE DRAWINGS

These and other features of this invention will now be described with reference to the drawings of preferred embodiments which are intended to illustrate and not to limit the invention. The drawings are greatly simplified for illustrative purposes and are not necessarily to scale.

FIG. 1 is a schematic section view of a half cell.

FIG. 2 is an initial discharge curves of examples and comparative examples.

FIG. 3 is discharge curves of examples and comparative examples at the end of evaluation.

FIG. 4 is a graph showing the cycles vs. capacity relationships in examples and comparative examples.

### DESCRIPTION OF THE SYMBOLS

1,8 A1 lead
2 Thermo-compression bonding tape
3 Kapton tape
4 Aluminum foil
5 Electrode mixture
6 Metal Li plate
7 Ni mesh
9 Separator
10 Aluminum laminate cell

### DETAILED DESCRIPTION OF EMBODIMENTS

According to the present invention, a ceramic material is provided whose main constituent is a lithium titanate of spinel structure expressed by Li₄Ti₅O₁₂ and to which trace constituents have been added as necessary, wherein such ceramic material typically contains the aforementioned lithium titanate by 90% or more, or preferably 95% or more. In this Specification, such ceramic material is sometimes referred to as “lithium-titanium complex oxide.” According to the present invention, the mode of the lithium-titanium complex oxide is not specifically limited, but typically it is in a fine particle state.

According to the present invention, the main crystalline system of the lithium titanate is a spinel structure. A lithium titanate having a spinel structure can be expressed by the composition formula Li₄Ti₅O₁₂ and confirmed by the presence of specific peaks by X-ray diffraction as explained later. The lithium-titanium complex oxide may have reaction byproducts such as Li₂TiO₃ and TiO₂ mixed in it. The smaller the amount of these byproducts, the better. To be specific, when the main peak intensities of Li₄Ti₅O₁₂, Li₂TiO₃ and TiO₂ phases detected from an X-ray diffraction pattern are given by I₁, I₂ and I₃, respectively, I₁/(I₁+I₂+I₃) is 96% or more.

According to the present invention, the lithium-titanium complex oxide may contain elements other than titanium, lithium and oxygen, where elements that may be contained include potassium, phosphorous, niobium, sulfur, silicon, zirconium, sodium and calcium, for example. Preferably these constituents are all virtually dissolved in the ceramic structure of the lithium titanate as oxides.

According to the present invention, the crystallite size of the lithium titanate is 520 to 590 Å. The term “crystallite size of the lithium titanate” is broadly interpreted and includes the effect of crystal strain. The value of crystallite size is the value D (111) calculated by Scherrer's equation (Equation 1) below from the X-ray diffraction peak on the lithium titanate (111) plane obtained by powder X-ray diffraction (XRD):

D(111)=K×λ/β cos θ (Equation 1)

Here, D (111) is the crystallite size, K is a constant that varies depending on the measurement apparatus, λ is the wavelength of the X-ray, θ is the Bragg angle formed by the X-ray and (111) plane, and β is the half width of the peak on the (111) plane.

The specific method of obtaining the crystallite size is described in detail in the “Examples” section. A lithium-titanium complex oxide whose crystallite size is within the aforementioned range allows fine particles to be formed while maintaining high crystallinity and is therefore useful as an active electrode material for a lithium ion secondary battery offering a high initial capacity such as 160 mAh/g as well as high rate characteristics such as 50% or more at the 10-C rate.

Under the solid phase method, lithium-titanium complex oxide is typically obtained by mixing and sintering a titanium compound, lithium compound, and trace constituents. For the titanium source, a titanium oxide is typically used. For the lithium source, lithium salt or lithium hydroxide is typically used. As a lithium salt, carbonate or acetate, etc., may be used. If a lithium hydroxide is used, it may be a hydrate such as monohydrate or the like. For the lithium source, two or more of the foregoing may be combined.

For the potassium source, a carbonate, potassium hydroxide or potassium salt is typically used. Examples of the potassium salt include carbonate, hydrogen carbonate and acetate, etc. For the phosphorous source, if phosphorus is included, an ammonium phosphate, etc., can be used. By using a potassium dihydrogen phosphate, dipotassium hydrogenphosphate, tripotassium phosphate, or other substance containing both potassium and phosphorous, the potassium source and lithium source can be satisfied by only one compound. For the niobium source if niobium is included, a niobium oxide is typically used.

According to the present invention, a high-quality lithium-titanium complex oxide can be obtained using the solid phase method. Under the solid phase method, the aforementioned materials are weighed and then mixed and sintered. The mixing process may be wet mixing or dry mixing. Wet mixing is a method whereby dispersion medium such as water, ethanol or the like is used together with a ball mill, planetary ball mill, bead mill, wet jet mill, etc. Dry mixing is a method whereby no dispersion medium is used and a ball mill, planetary ball mill, bead mill, jet mill, flow-type mixer, or machine capable of applying compressive force or shearing force to achieve precision mixing or efficiently add mechano-chemical effect such as Nobilta (Hosokawa Micron), Miralo (Nara Machinery), or the like is used.

In the case of dry mixing, alcohol or acetylacetone, etc. can be used as a mixing auxiliary. Examples of the alcohol include methanol, ethanol, propanol, butanol, ethylene glycol, propylene glycol, diethylene glycol, triethylene glycol, dipropylene glycol, tripropylene glycol, glycerin, and the like. By adding them by a trace amount, the efficiency of mixing will be increased.

In the case of wet mixing, load in the drying process can be reduced by minimizing the dispersion medium used. If the dispersion medium is too little, the slurry becomes highly viscous and may clog the piping or present other problems. Accordingly, preferably a small amount (approx. 5 percent by mass or less) of dispersion medium such as polyacrylate or the like is used, where desirably the solid content is adjusted to a range of 4.8 to 6.5 mol/L for lithium material and 6 to 7.9 mol/L for titanium oxide at the time of mixing.

At the time of mixing, the order in which the dispersion medium (water, etc.), dispersant, lithium material and titanium material are added does not affect the quality of the final product. For example, the dispersion medium, dispersant, lithium material and titanium material can be added, in this order, under agitation using agitating blades. Or, the lithium material and titanium material can be roughly mixed beforehand and then added in the last step, as it saves mixing time and increases efficiency.

Typical sintering conditions after mixing are to sinter in atmosphere at 800 to 900° C. for 1 hour or more. Preferably the sintered material is physically crushed using a grinder. The specific surface area of the lithium-titanium complex oxide before the volume crushing as explained later is preferably 1.5 to 5.0 m²/g, or more preferably 1.9 to 4.5 m²/g.

Although the solid phase method discussed above is advantageous in terms of cost among the manufacturing methods for a lithium-titanium complex oxide, the sol-gel method or wet method using alkoxide, etc. can also be adopted.

Preferably the lithium-titanium complex oxide thus obtained is crushed as deemed appropriate in order to control its crystallite size. Preferred examples of crushing include adding a high cracking energy to crack the primary particle. Here, volume crushing is preferred, because it can minimize the damage to the crystal and also prevent chippings, or specifically, amorphous fine particles, from increasing per unit weight. Volume crushing is a process where compressive force, shearing force, impact force, etc., is used to destroy the entire particle to be crushed, which is different from surface crushing where the particle to be crushed is ground down to shave away the surface. Volume crushing is implemented by, for example, mixing in a batch bead mill 1 part by mass of the sintered lithium-titanium complex oxide powder, 2 to 12 parts by mass of Zr beads of 3 to 30 mm in diameter, and 1 to 10 percent by weight of ethanol relative to the lithium-titanium complex oxide powder, with the mixture crushed for 30 to 120 minutes.

On the other hand, crushing under surface crushing conditions where the particle surface is worn, may be used, but such method is not necessarily preferable. The specific surface area can be increased easily under such crushing conditions, but the primary particle size does not decrease much and the particle surface is damaged, causing the crystallinity to drop to an undesirable level and a large amount of amorphous fine particles to generate that do not contribute to the insertion/desorption reaction of lithium ions.

After the crushing, heat treatment of, for example, 0.5 to 3 hours at 350 to 600° C., can be applied to repair the damage sustained by the crystal surface through cracking-type crushing, which improves the number of particles that contribute to the insertion/desorption reaction of lithium ions per unit powder. The ambient environment of heat treatment may be atmosphere, but it is preferably a dry gas or inert gas atmosphere of the same composition as air. Heat treatment after the crushing process such as volume crushing causes amorphous particles such as chippings to grow in size. The specific surface area of the powder is preferably 8 to 12 m²/g. The maximum primary particle size of the powder is preferably 1.5 μm or less, or more preferably 1.0 to 1.4 μm. It was found that a powder satisfying the above conditions would provide a good electrode coating solution and smooth coating film. If the specific surface area of the powder is too large, more solvent and binder will be required in the electrode coating solution kneading step, causing large secondary agglomerations to form and thereby making it difficult to obtain a uniformly dispersed coating solution. On the other hand, a large primary particle size makes it difficult to form secondary agglomerations of appropriate size, and consequently to obtain a smooth coating film. Roughness of coating film can cause the film to separate or capacity to fluctuate. Under the present invention, the specific surface area of the powder is measured by the BET method.

The size of the primary particle of lithium-titanium complex oxide is calculated as the Feret diameter using an electron microscope image, and the diameters of at least 300 particles are measured, of which the maximum value is obtained. The specific method to obtain the Feret diameter is explained in detail in the Examples section.

With a lithium-titanium complex oxide whose primary particle size tends to grow more than the crystallite size at the synthesis temperature, a small ratio of crystallite size per particle causes the distance from the particle surface to the crystal particle to fluctuate significantly, which in turn tends to result in lower response in the insertion/desorption reaction of lithium ions and lower rate characteristics. To raise the rate characteristics, the crystallite size per particle is adjusted to preferably 4 or less, or more preferably 2.7 to 3.6. The crystallite size per particle is calculated by A₁/A₂, where A₁ represents the specific surface area-equivalent diameter calculated from the specific surface area of the powder as measured by the BET method, while A₂ represents the value D (111) as calculated using Scherrer's equation (Equation 1) presented above.

The lithium-titanium complex oxide proposed by the present invention can be used favorably as an active electrode material for lithium ion secondary batteries. It can be used for positive electrodes or negative electrodes. The configurations and manufacturing methods of electrodes containing the lithium-titanium complex oxide as their active material and lithium ion secondary battery having such electrodes can apply any prior technology as deemed appropriate. Also in the examples explained later, an example of manufacturing a lithium ion secondary battery is presented. Typically a suspension containing the lithium-titanium complex oxide as an active material, conductive auxiliary, binder, and solvent is prepared and this electrode solution is applied to the metal piece of the collector, etc., and dried, and then pressed to form an electrode. The conductive auxiliary may be acetylene black, for example, the binder may be any of various resins or more specifically fluororesins, etc., and the solvent may be n-methyl-2-pyrrolidone, etc. A lithium ion secondary battery can be constituted from the electrodes thus obtained, electrolyte solution containing lithium salt, and separator, etc.

### EXAMPLES

The present invention is explained more specifically using examples below. It should be noted, however, that the present invention is not limited to the embodiments described in these examples. First, how the samples obtained by the examples/comparative examples were analyzed and evaluated is explained.

(Measurement Method for Crystallite Size)

The crystallite size of the lithium-titanium complex oxide powder is the value D (111) calculated by Scherrer's equation (Equation 1) below from the half width of the peak on the lithium titanate (111) plane obtained by XRD (Ultima IV by Rigaku):

D(111)=K×λ/β cos θ (Equation 1)

Here, D (111) is the crystallite size, K is 0.9, λ is 0.154054 nm (Kα1 wavelength of Cu), θ is the Bragg angle formed by the X-ray and (111) plane (2θ=18.4), and β is the half width of the (111) plane. β, being the half width of the (111) plane, is the Kα1 half width of the peak obtained by Kα1/Kα2 splitting of the diffraction line peak of the diffraction pattern (111) using the Pearson VII function. The XRD measurement conditions were as follows: Target Cu, acceleration voltage 40 kV, discharge current 40 mA, divergence slit width 1°, divergence longitudinal slit width 10 mm.

(Calculation Method for BET Size/Crystalline Size)

The specific surface area S was measured by the BET method and then the particle size was calculated using the calculation formula (Equation 2) by assuming that all particles are spheres of the same diameter.

BET size=1.724/S (Equation 2)

(X-ray Diffraction of Powder)

In the above powder XRD measurement, the ratio of the peak intensity of Li₄Ti₅O₁₂ (111) plane (2θ=18.4), peak intensity of Li₂TiO₃ (−133) plane (2θ=43.6) and peak intensity of rutile TiO₂ (110) plane (2θ=27.4) was calculated.

(Particle Size Measurement—SEM Observation)

The maximum primary size of the lithium-titanium complex particle was measured using a ×30,000 photograph taken by a scanning electron microscope (SEM, S4800 by Hitachi). The photograph was captured at a screen size of 7.3 cm×9.5 cm, and the Feret diameter was measured for all particles in the photograph, of which the maximum value was taken as the maximum primary size. If less than 300 particles were measured, multiple SEM photographs were taken with different fields of view until at least 300 particles were measured. The Feret diameter is a tangential diameter in a fixed direction, defined by the distance between two parallel tangential lines sandwiching a particle (Society of Powder Technology, Japan, ed., “Particle Measurement Technology (in Japanese),” Nikkan Kogyo Shimbun, P.7 (1994)).

(Battery Evaluation—Half Cell)

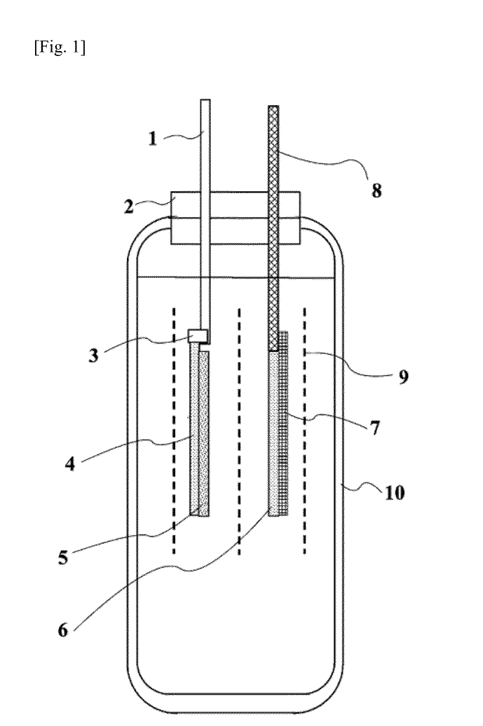

FIG. 1 is a schematic section view of a half cell. An electrode mixture was produced using the lithium-titanium complex oxide as an active material. Eighty-two parts by weight of the obtained lithium-titanium complex oxide, 9 parts by weight of acetylene black as a conductive auxiliary, 9 parts by weight of fluororesin as a binder, and n-methyl-2-pyrrolidone as a solvent, were mixed together. The electrode mixture 5 thus mixed was applied on an aluminum foil 4 using the doctor blade method to a coating weight of 0.003 g/cm². The coated foil was vacuum-dried at 130° C. and then roll-pressed. Thereafter, an area of 10 cm² was stamped out from the pressed foil to obtain a positive electrode of a battery. For the negative electrode, a metal Li plate 6 attached to a Ni mesh 7 was used. For the electrolyte solution, ethylene carbonate and diethyl carbonate were mixed at a volume ratio of 1:2, and then 1 mol/L of LiPF₆ was dissolved into the obtained solvent. For a separator 9, a porous cellulose membrane was used. Also, as illustrated, A1 leads 1, 8 were fixed using a thermo-compression bonding tape 2, and the A1 lead 1 was fixed to the positive electrode using a Kapton tape 3. An aluminum laminate cell 10 was thus prepared. This battery was used to measure the initial discharge capacity. The battery was charged to 1.0 V at a constant current of 0.105 mA/cm² (0.2 C) in current density, and then discharged to 3.0 V, with the cycle repeated three times and the discharge capacity in the third cycle used as the value of initial discharge capacity. Next, the rate characteristics were measured. Measurements were taken by gradually increasing the charge/discharge rate from 0.2 C to 1 C, 2 C, 3 C, 5 C and 10 C. The ratio of the discharge capacity at the 10-C rate in the second cycle and theoretical discharge capacity (175 mAh/g) was indicated as the rate characteristics (%).

### Example 1

Lithium carbonate (primary particle of 2 μm or less) and titanium oxide (primary particle of 0.3 m or less) were added to pure water of a quantity that would give 4.8 mol/L of lithium carbonate and 6 mol/L of titanium oxide. As a dispersant, 1 part by weight of ammonium polyacrylate was added relative to 130 parts by weight of titanium oxide. The Li:Ti mol ratio was adjusted to 4:5 when the ingredients were introduced and mixed. The mixed slurry was put in a pot and mixed under agitation in a zirconium bead mill of 1.5 mm in diameter, after which the dispersant was removed in a spray dryer and the remaining mixture was heat-treated in atmosphere at 800° C. for 3 hours. Thereafter, a grinder was used to crush the atomized granules, with the crushed granules passed through a sieve of 60 μm in mesh size. In this stage, the specific surface area was 4.4 m²/g. This powder was dry-crushed for 90 minutes in a vibration mill using Zr beads of 10 mm in diameter as the media and by adding and mixing 0.5 percent by weight of ethanol. Based on the XRD peak intensity ratio of the obtained powder, Li₄Ti₅O₁₂/(Li₄Ti₅O₁₂+Li₂TiO₃+TiO₂+Li₂CO₃) was 96.5%. Other measured results are shown in Table 1. When the electrode mixture was applied on an aluminum foil to form a battery, the electrode coating film was smooth but it retained visible streaks when the electrode coating film was applied.

### Example 2

The materials were mixed at the same blending ratio as in Example 1 and dried, and then heat-treated in atmosphere at 880° C. for 3 hours. A grinder was used to crush the powder, with the crushed powder passed through a sieve of 60 μm in mesh size. Based on the XRD peak intensity ratio, Li₄Ti₅O₁₂/(Li₄Ti₅O₁₂+Li₂TiO₃+TiO₂+Li₂CO₃) was 97%, and the specific surface area was 2.2 m²/g. This powder was dry-crushed for 90 minutes in a vibration mill under the same media conditions as in Example 1, and then heat-treated at 400° C. for 3 hours. The ambient environment of heat treatment was dry gas of the same composition as atmosphere. The measured results of the lithium-titanium complex oxide thus obtained are shown in Table 1. When the electrode mixture was applied on an aluminum foil to form a battery, the electrode coating film was smooth and good, free from any visible mottled appearance or streaking.

### Example 3

A lithium-titanium complex oxide was obtained in the same manner as in Example 2, except that the dry-crushing time in the vibration mill was changed to 60 minutes. The measured results are shown in Table 1. When the electrode mixture was applied on an aluminum foil to form a battery, the electrode coating film was smooth, free from any visible mottled appearance or streaking.

### Example 4

The materials were mixed at the same blending ratio as in Example 1 and dried, and then heat-treated in atmosphere at 900° C. for 3 hours. A grinder was used to crush the powder, with the crushed powder passed through a sieve of 60 μm in mesh size. Based on the XRD peak intensity ratio, Li₄Ti₅O₁₂/(Li₄Ti₅O₁₂+Li₂TiO₃+TiO₂+Li₂CO₃) was 97%, and the specific surface area was 1.9 m²/g. This powder was dry-crushed for 60 minutes in a vibration mill under the same media conditions as in Example 1, and then heat-treated at 400° C. for 3 hours. The measured results of the lithium-titanium complex oxide thus obtained are shown in Table 1. When the electrode mixture was applied on an aluminum foil to form a battery, the electrode coating film was smooth, free from any visible mottled appearance or streaking.

### Example 5

A lithium-titanium complex oxide was obtained in the same manner as in Example 4, except that the dry-crushing time in the vibration mill was changed to 60 minutes. The measured results are shown in Table 1. When the electrode mixture was applied on an aluminum foil to form a battery, the viscosity of the electrode coating solution was lower than in other examples and adjusting the thickness of the paste was difficult when making a coating film. The film had undulations of a little more than +5 μm.

### Comparative Example 1

The materials were mixed at the same blending ratio as in Example 1 and dried, and then heat-treated in atmosphere at 860° C. for 3 hours. A grinder was used to crush the powder, with the crushed powder passed through a sieve of 60 μm in mesh size. Based on the XRD peak intensity ratio, Li₄Ti₅O₁₂/(Li₄Ti₅O₁₂+Li₂TiO₃+TiO₂+Li₂CO₃) was 97%, and the specific surface area was 3.6 m²/g. This powder was not dry-crushed. The measured results of the lithium-titanium complex oxide thus obtained are shown in Table 1. When preparing an electrode coating solution to form a battery, the viscosity of the coating solution tended to be low and forming an electrode coating film of constant thickness was difficult even when the amount of solvent or binder was adjusted.

### Comparative Example 2

The materials were mixed under agitation, dried, and heat-treated in the same manner as in Comparative Example 1, and then dry-crushed for 90 minutes in a vibration mill by adding Zr beads of 0.5 mm in diameter by 6 times the amount of lithium-titanium complex oxide, as well as 0.5 percent by weight of ethanol. The measured results of the lithium-titanium complex oxide thus obtained are shown in Table 1. When preparing an electrode coating solution to form a battery, more solvent and binder were required and eliminating the large agglomerations or so-called “clumps” in the coating solution was not easy. The electrode coating film had large undulations. An area of the electrode coating film where undulations were within ±3 μm was selected and used for cell evaluation.

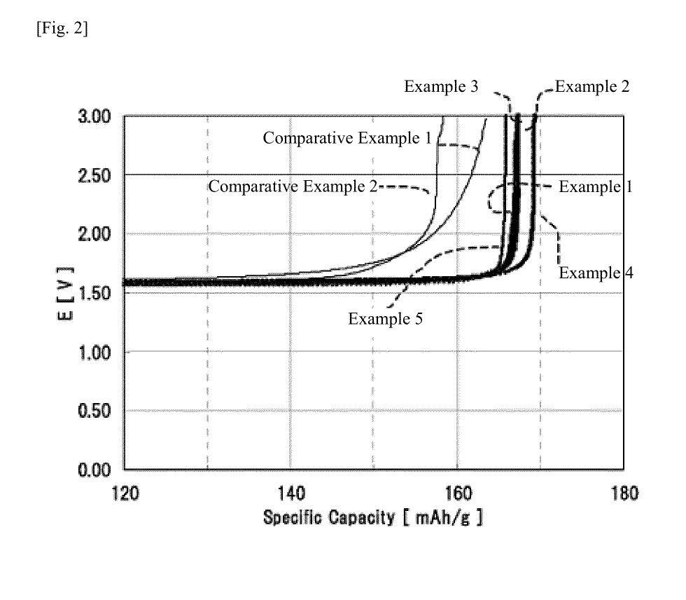

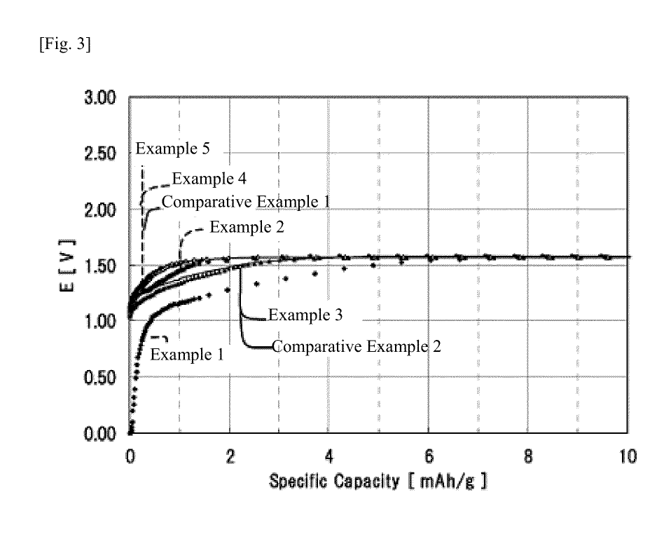

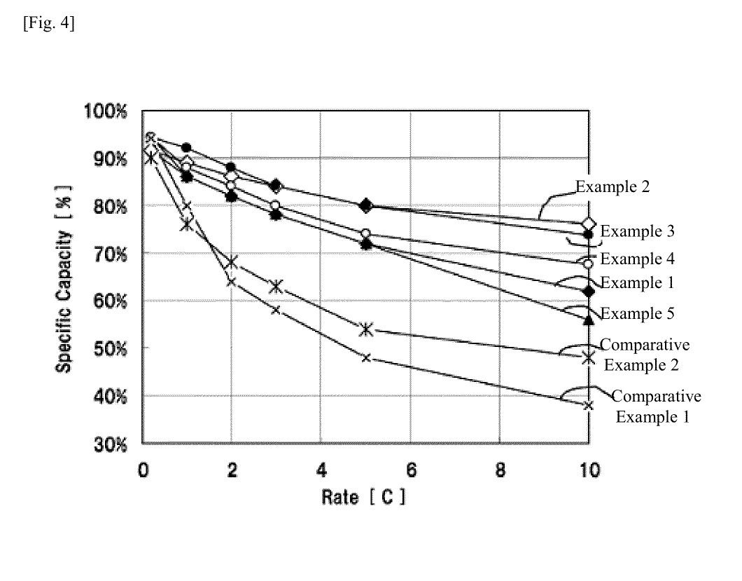

The evaluation results of examples and comparative examples are summarized in Table 1. Also, the initial discharge curves, discharge curves at the end of evaluation, and cycles vs. capacity relationships, of examples and comparative examples, are summarized in FIGS. 2, 3, and 4, respectively.

TABLE 1

| | A | B | C | D | E | F | G | H | I | J | K |
|---|---|---|---|---|---|---|---|---|---|---|---|
| 1 | 0.155 | 520 | 1.1 | 14 | 2.4 | 160 | 165 | 7 | 158 | 68% | Δ |
| 2 | 0.154 | 524 | 1.3 | 12 | 2.7 | 160 | 165 | 2 | 163 | 75% | ⊚ |
| 3 | 0.146 | 551 | 1.3 | 10 | 3.1 | 165 | 165 | 4 | 161 | 74% | ⊚ |
| 4 | 0.139 | 576 | 1.4 | 8.2 | 3.6 | 165 | 168 | 2 | 166 | 67% | ⊚ |
| 5 | 0.137 | 588 | 1.8 | 6.1 | 4.8 | 165 | 165 | 2 | 163 | 56% | Δ |
| 6 | 0.13 | 519 | 2.2 | 3.6 | 7.6 | 165 | 165 | 2 | 163 | 36% | X |
| 7 | 0.135 | 596 | 2.0 | 10 | 2.9 | 158 | 145 | 3 | 142 | 48% | X |

1: Example 1
2: Example 2
3: Example 3
4: Example 4
5: Example 5
6: Comparative Example 1
7: Comparative Example 2
A: Half width
B: Crystallite size [Å]
C: Maximum primary particle size [μm]
D: Specific surface area [m²/g]
E: BET size/crystallite size
F: Initial capacity [mAh/g]
G: Discharge curve, initial, end of voltage change [mAh/g]
H: Discharge curve, end, start of voltage drop [mAh/g]
I: Effective capacity [mAh/g]
J: 10-C rate capacity/initial capacity (rate characteristics)
K: Shape of coating film

As can be seen from the above results, a lithium ion secondary battery containing a lithium-titanium complex oxide conforming to the present invention, as an active electrode material, can provide a high initial discharge capacity, excellent rate characteristics, and good smoothness of electrodes.

In the present disclosure where conditions and/or structures are not specified, a skilled artisan in the art can readily provide such conditions and/or structures, in view of the present disclosure, as a matter of routine experimentation. Also, in the present disclosure including the examples described above, any ranges applied in some embodiments may include or exclude the lower and/or upper endpoints, and any values of variables indicated may refer to precise values or approximate values and include equivalents, and may refer to average, median, representative, majority, etc. in some embodiments. Further, in this disclosure, “a” may refer to a species or a genus including multiple species, and “the invention” or “the present invention” may refer to at least one of the embodiments or aspects explicitly, necessarily, or inherently disclosed herein. In this disclosure, any defined meanings do not necessarily exclude ordinary and customary meanings in some embodiments.

The present application claims priority to Japanese Patent Application No. 2011-241735, filed Nov. 2, 2011, the disclosure of which is incorporated herein by reference in its entirety.

It will be understood by those of skill in the art that numerous and various modifications can be made without departing from the spirit of the present invention. Therefore, it should be clearly understood that the forms of the present invention are illustrative only and are not intended to limit the scope of the present invention.

We/I claim:

1. A lithium-titanium complex oxide whose main constituent is Li₄Ti₅O₁₂, wherein, when main peak intensities of Li₄Ti₅O₁₂, Li₂TiO₃ and TiO₂ detected from an X-ray diffraction pattern are given by I₁, I₂ and I₃, respectively, I₁/(I₁+I₂+I₃) is 96% or more, and a crystallite size of Li₄Ti₅O₁₂ as calculated by Scherrer's equation from a half width of a peak on a Li₄Ti₅O₁₂ (111) plane is 520 Å to 590 Å.

2. A lithium-titanium complex oxide according to claim 1, wherein a specific surface area obtained by the BET method is 8 to 12 m²/g.

3. A lithium-titanium complex oxide according to claim 1, wherein the maximum size of the primary particle is 1.5 μm or less.

4. A lithium-titanium complex oxide according to claim 2, wherein the maximum size of the primary particle is 1.5 μm or less.

5. A lithium-titanium complex oxide according to claim 1, wherein A₁/A₂ is 4 or less, where A₁ represents a specific surface area-equivalent diameter of the lithium-titanium complex oxide as calculated from a specific surface area obtained by the BET method, while A₂ represents a crystallite size of Li₄Ti₅O₁₂ as calculated by Scherrer's equation.

6. A lithium-titanium complex oxide according to claim 2, wherein A₁/A₂ is 4 or less, where A₁ represents a specific surface area-equivalent diameter of the lithium-titanium complex oxide as calculated from a specific surface area obtained by the BET method, while A₂ represents a crystallite size of Li₄Ti₅O₁₂ as calculated by Scherrer's equation.

7. A lithium-titanium complex oxide according to claim 3, wherein A₁/A₂ is 4 or less, where A₁ represents a specific surface area-equivalent diameter of the lithium-titanium complex oxide as calculated from a specific surface area obtained by the BET method, while A₂ represents a crystallite size of Li₄Ti₅O₁₂ as calculated by Scherrer's equation.

8. A lithium-titanium complex oxide according to claim 4, wherein the maximum size of the primary particle is 1.5 μm or less.

9. A positive electrode for a battery containing the lithium-titanium complex oxide according to claim 1 as a positive electrode active material.

10. A negative electrode for a battery containing the lithium-titanium complex oxide according to claim 1 as a negative electrode active material.

11. A lithium ion secondary battery having a positive electrode containing the lithium-titanium complex oxide according to claim 1 as a positive electrode active material, or a negative electrode containing the lithium-titanium complex oxide according to claim 1 as a negative electrode active material.
